(19) United States
(12) Patent Application Publication
(10) Pub. No.: US 2026/0091550 A1
(43) Pub. Date: Apr. 2, 2026

(54) PRODUCTION APPARATUS FOR SHAPED BODY CONTAINING SEDIMENTING PARTICLES AND METHOD FOR PRODUCING SHAPED BODY CONTAINING SEDIMENTING PARTICLES

(71) Applicants: Daisuke Arai, Tokyo (JP); Hidekazu Yaginuma, Kanagawa (JP); Takahiko Matsumoto, Kanagawa (JP); Yusuke Nonoyama, Kanagawa (JP); Atsushi Miyaoka, Kanagawa (JP); Naoki Satoh, Kanagawa (JP); Ryuta Watanabe, Kanagawa (JP); Shun Anzai, Kanagawa (JP)

(72) Inventors: Daisuke Arai, Tokyo (JP); Hidekazu Yaginuma, Kanagawa (JP); Takahiko Matsumoto, Kanagawa (JP); Yusuke Nonoyama, Kanagawa (JP); Atsushi Miyaoka, Kanagawa (JP); Naoki Satoh, Kanagawa (JP); Ryuta Watanabe, Kanagawa (JP); Shun Anzai, Kanagawa (JP)

(73) Assignee: Ricoh Company, Ltd., Tokyo (JP)

(21) Appl. No.: 19/338,389

(22) Filed: Sep. 24, 2025

(30) Foreign Application Priority Data
Sep. 30, 2024 (JP) 2024-170734
Jul. 24, 2025 (JP) 2025-123995

(51) Int. Cl. B29C 64/112; B29C 64/209; B29C 64/255; B33Y 10/00; B33Y 30/00; B33Y 70/10

(52) U.S. Cl. CPC B29C 64/112; B29C 64/209; B29C 64/255; B33Y 10/00; B33Y 30/00; B33Y 70/10

(57) ABSTRACT

A production apparatus for a shaped body containing sedimenting particles and a method for producing a shaped body containing sedimenting particles that can continuously mass-produce shaped bodies containing a fixed amount of sedimenting particles. A production apparatus for a shaped body containing sedimenting particles, the apparatus being provided with an ejection head that ejects a liquid containing sedimenting particles, as a liquid droplet, onto a droplet landing element, and a supply apparatus that supplies the liquid to the ejection head, wherein the supply apparatus includes a storage module that extends in a direction transverse to the vertical direction and that stores the liquid, a supply module that supplies the liquid in the storage module from one end in a central axis direction of the storage module, and an agitation unit that rotates the storage module in a circumferential direction about the central axis of the storage module to agitate the liquid inside the storage module.

### CROSS-REFERENCE TO RELATED APPLICATIONS

The present application claims priority under 35 U.S.C. § 119 to Japanese Patent Application No. 2025-123995, filed Jul. 24, 2025, which itself claims priority from Japanese Patent Application No. 2024-170734, filed Sep. 30, 2024. The contents of which are incorporated herein by reference in their entirety.

### BACKGROUND OF THE INVENTION

### Field of the Invention

The present invention relates to a production apparatus for a shaped body containing sedimenting particles and a method for producing a shaped body containing sedimenting particles.

### Description of Related Art

Conventionally, as a technology for ejecting liquid bodies (liquids), such as ink, at desired locations, inkjet-type liquid droplet formation apparatuses are known.

In recent years, liquid droplet formation apparatuses have been required to eject various types of liquids different from the inks used in conventional two-dimensional printing. For example, the liquids to be ejected may include not only solutions but also be dispersions. Examples of the dispersed materials (particles) contained in the dispersions include materials from biological sources, such as cells or genes.

When a liquid droplet ejection apparatus ejects a dispersion as mentioned above, the dispersed material can sometimes sediment in a liquid chamber. In the following description, a dispersed material that sediments in a dispersion may be referred to as “sedimenting particles”. When sedimenting particles sediment, even if the amounts of liquid droplets that are ejected are uniform, the concentration of sedimenting particles included in the ejected liquid changes and it becomes difficult to stably eject a desired amount of the dispersed material. When a large amount of a dispersion is ejected over a long period of time, the sedimenting particles tend to sediment in the dispersion as the work time elapses, and the above-mentioned problem particularly tends to occur.

In response to such conventional problems, configurations for liquid droplet ejection means in which two suction/discharge members are connected to a liquid holding module for storing a dispersion including sedimenting particles have been proposed (see, for example, Patent Document 1). In the apparatus configuration in Patent Document 1, two suction/discharge members repeat operations by alternately switching between using one of the suction/discharge members to suction the dispersion in the liquid holding module and for using the other suction/discharge member to separately discharge (i.e. supply) the dispersion into the liquid holding module. At this time, the dispersion can also be supplied to the liquid holding module by making the discharged amount of the dispersion greater than the suctioned amount. As a result, the dispersion in the liquid holding module is made to flow and is agitated, thereby suppressing sedimentation of the sedimenting particles. Furthermore, the dispersion can also be supplied to the liquid holding module.

### SUMMARY OF THE INVENTION

In the configuration in Patent Document 1 above, when switching operations between suction and discharge in the respective suction/discharge members, there is a time period during which liquid is not supplied from either of the suction/discharge members, i.e., when the liquid supply is temporarily suspended. Thus, the supply is intermittent. Additionally, in the case in which liquid droplets are ejected continuously for a long period of time, there is a risk that the dispersion in the liquid holding module will temporarily decrease or become depleted. In this case, there is a risk that the liquid droplet ejection state will change or the liquid droplets will not be able to be ejected.

Therefore, there is room for improvement in the apparatus described in Patent Document 1 from with respect to be continuous and stable ejection of liquid droplets in which the dispersed material (sedimenting particles) content is stable.

The present invention was made in view of these circumstances, and an objective of the present invention is to provide a production apparatus for a shaped body containing sedimenting particles and a method for producing a shaped body containing sedimenting particles that can continuously mass-produce shaped bodies containing a fixed amount of sedimenting particles.

In order to solve the above-mentioned problem, one aspect of the present invention provides a production apparatus for a shaped body containing sedimenting particles, the apparatus being provided with an ejection head that ejects a liquid containing sedimenting particles, as a liquid droplet, onto a droplet landing element, and a supply apparatus that supplies the liquid to the ejection head, wherein the supply apparatus includes a storage module that extends in a direction transverse to the vertical direction and that stores the liquid, a supply module that supplies the liquid in the storage module from one end in a central axis direction of the storage module, and an agitation unit that rotates the storage module in a circumferential direction about the central axis of the storage module to agitate the liquid inside the storage module.

In the present invention, it is possible to provide the production apparatus for a shaped body containing sedimenting particles and the method for producing a shaped body containing sedimenting particles that can continuously mass-produce shaped bodies containing a fixed amount of sedimenting particles.

### BRIEF DESCRIPTION OF THE DRAWINGS

FIG. 1 is a schematic diagram of a production apparatus 1 for a shaped body containing sedimenting particles of a first embodiment.

FIG. 2 is a partially enlarged view of the production apparatus 1 for a shaped body containing sedimenting particles.

FIG. 3 is a partially enlarged view of the production apparatus 1 for a shaped body containing sedimenting particles.

FIG. 4 is a partially enlarged view illustrating a modified example of the production apparatus for a shaped body containing sedimenting particles.

FIG. 5 is an explanatory diagram for a production apparatus 3 for a shaped body containing sedimenting particles of a second embodiment.

FIG. 6 is an explanatory diagram for a production apparatus 4 for a shaped body containing sedimenting particles of the second embodiment.

FIG. 7 is an explanatory diagram for a production apparatus 5 for a shaped body containing sedimenting particles of a third embodiment.

### DETAILED DESCRIPTION OF THE INVENTION

### First Embodiment

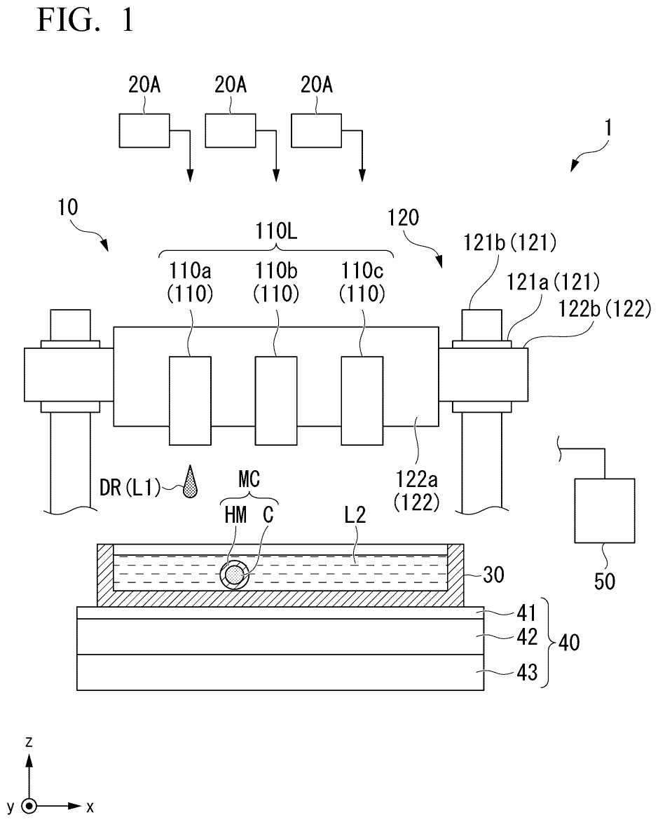

Hereinafter, a production apparatus for a shaped body containing sedimenting particles and a method for producing a shaped body containing sedimenting particles are described with reference to FIG. 1 to FIG. 4. In all of the drawings below, the dimensions and proportions of the respective constituent elements are changed, as appropriate, in order to make the drawings easier to see.

In the following description, an xyz Cartesian coordinate system is set, and the positional relationships between the respective elements are described with reference to this Cartesian coordinate system. Herein, a direction within the horizontal plane is defined as the x direction, a direction orthogonal to the x direction in the horizontal plane is defined as the y direction, and a direction (i.e., the vertical direction) orthogonal to each of the x direction and the y direction is defined as the z direction.

Additionally, the upward direction along the vertical axis is defined as the +z direction and the downward direction along the vertical axis is defined as the −z direction. In the following description, the same meanings are applied to the term “up” from “upper part” and “upper surface” and the term “low” from “lower part” and “lower surface”.

Further, in the following description, the term “plain view” refers to viewing a target object from above, and the term “planar shape” refers to a shape of the target object as viewed from above.

### Production Apparatus for Shaped Body Containing Sedimenting Particles

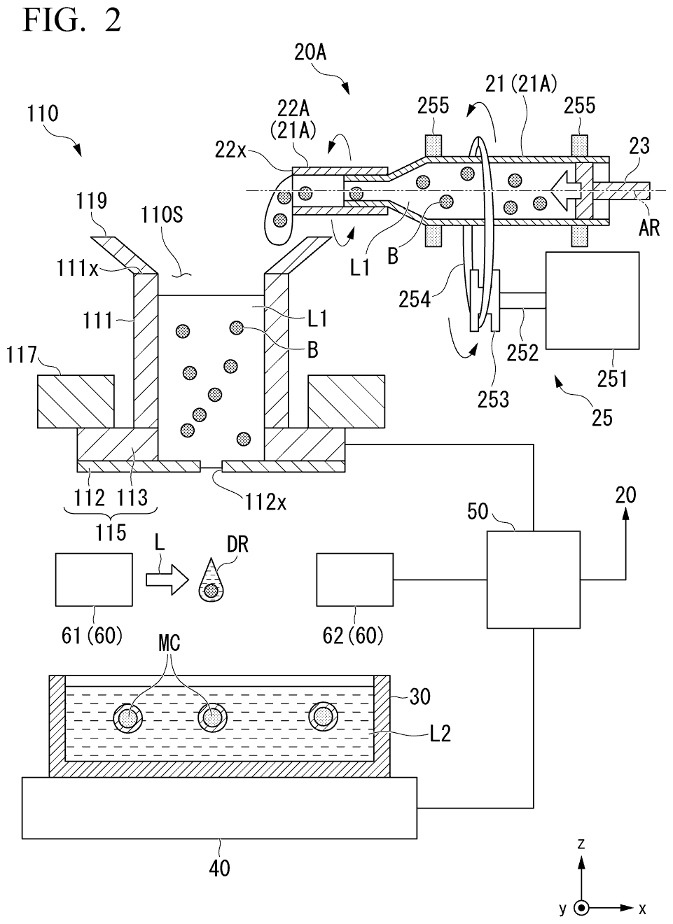

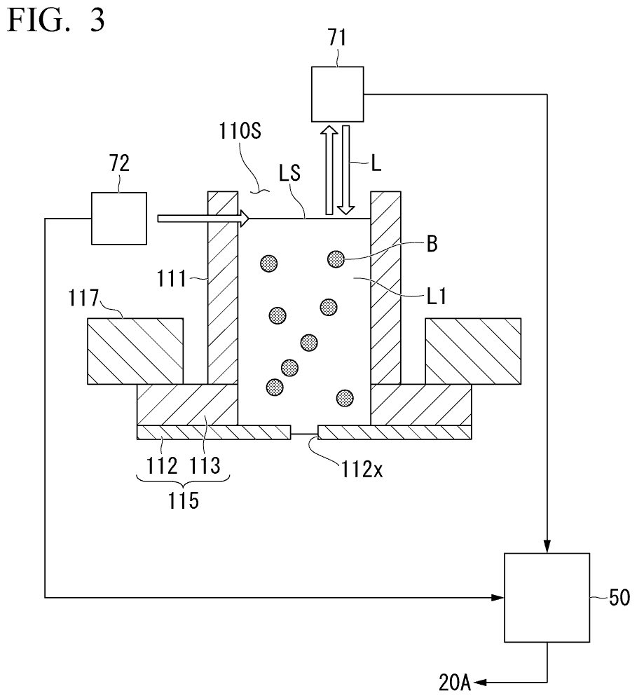

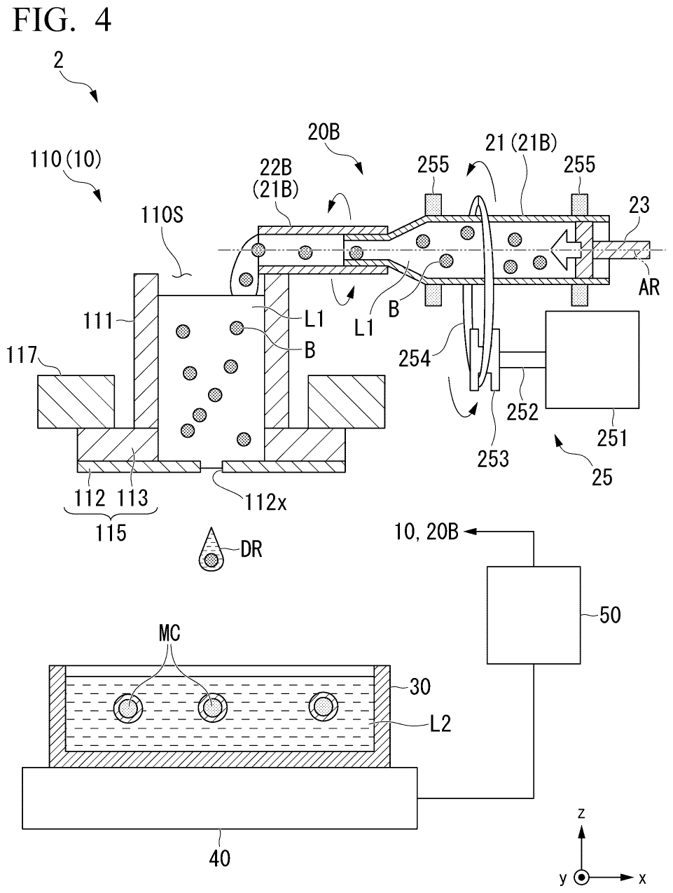

FIG. 1 is a schematic view of a production apparatus 1 for a shaped body containing sedimenting particles of the present embodiment. FIGS. 2 and 3 are partially enlarged views of the production apparatus 1 for a shaped body containing sedimenting particles. FIG. 4 is a partially enlarged view indicating a modified example of a production apparatus for a shaped body containing sedimenting particles.

As indicated in FIG. 1, the production apparatus 1 for a shaped body containing sedimenting particles includes an ejection unit 10, a supply apparatus 20A, and a droplet landing element 30. Additionally, the production apparatus 1 for a shaped body containing sedimenting particles includes a placement module 40 and a control unit 50. In the following description, the production apparatus for a shaped body containing sedimenting particles may be referred to simply as “production apparatus”.

In the production apparatus for a shaped body containing sedimenting particles and the method for producing a shaped body containing sedimenting particles of the present embodiment, a desired shaped body can be produced by using sedimenting particles.

In the present specification, “sedimenting particles” refer to a dispersed material that sediments in a dispersion. Examples of sedimenting particles include biomaterials, pigments contained in industrial inks, wet toners, and resin particles.

In the present specification, “biomaterials” refer to materials from biological sources. Examples of biomaterials include biomolecules such as proteins, cells, spheroids, microbes, etc. Such biomaterials gradually sediment when they are dispersed in dispersion media, such as buffer solutions, without using a dispersant. Therefore, these biomaterials correspond to the sedimenting particles in the present invention.

Additionally, in the present specification, the “shaped body containing sedimenting particles” refers to a shaped body formed using sedimenting particles as the material. For example, shaped bodies containing sedimenting particles include microcapsules infused with sedimenting particles, cell sheets produced by laying cells that are sedimenting particles, structures (three-dimensional shaped articles) that are produced by stacking proteins or cells, etc.

The present embodiment is described for the case in which microcapsules MC are produced as the shaped bodies containing sedimenting particles, the microcapsules MC including a biomaterial that is a sedimenting particle as a core C, and the core C being covered by a hydrogel membrane HM. That is, in the production apparatus 1 and the method for producing a shaped body containing sedimenting particles of the present embodiment, liquid droplets DR of a liquid L1 containing a first substrate and a biomaterial constituting sedimenting particles are ejected and brought into contact with a liquid L2 containing a second substrate that reacts with the first substrate to form a hydrogel. As a result, microcapsules MC in which cores C are covered with a hydrogel membrane HM can be produced (see FIG. 1).

### First Substrate and Second Substrate

As the first substrate and the second substrate, there are not particularly limited as long as they form a cross-linked structure that gels by being mixed together, and they can be selected, as appropriate, in accordance with the purpose.

For example, the first substrate may specifically be a biopolymer such as collagen, elastin, gelatin, or fibroin; a coagulation factor such as fibrinogen; an adhesion factor such as fibronectin, laminin, and recombinant peptides; a metal salt of a polysaccharide compound such as alginic acid and gellan gum; a synthetic polymer such as polylactic acid and polyethylene glycol, etc. Any of these may be used as single type or in combination of two or more types.

The second substrate may specifically be a polysaccharide, a polyvalent metal salt, fibrinogen, thrombin, fibronectin, laminin, recombinant peptides, xanthan, chitin, tetrafunctional polyethylene glycol (tetra-PEG), etc. Any of these may be used as single type or in combination of two or more types.

It is preferable to determine the combination of the first substrate and the second substrate by conducting preliminary experiments to identify a combination that yields a hydrogel having the desired physical properties.

When using a biomaterial such as cells as the sedimenting particles as in the present embodiment, the obtained hydrogel should preferably be a material that does not adversely affect the biomaterial, such as by lowering the survival rate. For example, when using sodium alginate as the first substrate and using a calcium salt such as calcium chloride as the second substrate, the generated hydrogel (calcium alginate) is a material that is commonly used as a scaffold material for cells, which is favorable.

As the solvent (dispersion medium) for the liquid L1, there are no particular limitation as long as it is an aqueous solution that can dissolve the first substrate and that can disperse the sedimenting particles. When biomaterials (e.g., cells) are used as the sedimenting particles, a known buffer solution such as phosphate-buffered saline or Hank's balanced salt solution, a culture medium suitable for the cells being used, or an extracellular matrix (ECM) can be employed as the dispersion medium.

As the solvent (dispersion medium) for the liquid L2, there are no particular limitation as long as it is an aqueous solution that can dissolve the second substrate and that can disperse the sedimenting particles. As the solvent (dispersion medium) of the liquid L2, the same material as that used as the solvent (dispersion medium) for the liquid L1 can be employed.

### Cells

As examples of sedimenting particles contained in the liquid L1, there are typically cells that are biomaterials. By using cells as sedimenting particles, the obtained microcapsules MC become hydrogel particles encapsulating cells.

The cells are not particularly limited in terms of the type, etc. thereof, and can be selected, as appropriate, in accordance with the purpose. For example, taxonomically, the invention can be used for all cells, regardless of whether they are nuclear cells, prokaryotic cells, multicellular organism cells, or unicellular organism cells.

For example, as prokaryotic cells, there are animal cells, insect cells, plant cells, fungi, etc. Any of these may be used as single type or in combination of two or more types. Among these, animal cells are preferable. More preferably, when the cells form cell aggregates, adhesive cells are used. These cells exhibit a level of cellular adhesiveness such that they adhere with each other and do not become isolated unless a physicochemical treatment is applied.

As adhesive cells, there are not particularly limited, and they can be selected, as appropriate, in accordance with the purpose. For example, there are differentiated cells, undifferentiated cells, etc.

For example, as differentiated cells, there are hepatocytes, which are parenchymal cells from the liver; astrocytes; Kupffer cells; vascular endothelial cells; endothelial cells such as meatus endothelial cells and corneal endothelial cells; fibroblasts; osteoblasts; osteoclasts; periodontal ligament-derived cells; epidermal cells such as epidermal keratinocytes; tracheal epithelial cells; digestive tract epithelial cells; cervical epithelial cells; epithelial cells such as corneal epithelial cells; mammary gland cells; pericytes; muscle cells such as smooth muscle cells and cardiomyocytes; kidney cells; pancreatic Langerhans islet cells; nerve cells such as peripheral nerve cells and optic nerve cells; cartilage cells; and bone cells. The adhesive cells described above may be primary cells directly sampled from tissues or organs, or may be passaged a number of times therefrom.

As undifferentiated cells, there are not particularly limited, and they can be selected, as appropriate, in accordance with the purpose. For example, there are embryonic stem cells that are undifferentiated cells, pluripotent stem cells such as mesenchymal stem cells having pluripotency; unipotent stem cells such as vascular endothelial progenitor cells having unipotency; iPS cells, etc.

The above-mentioned cells may form cell aggregates (for example, spheres, spheroids, organoids).

The microcapsules MC obtained in this way have a core-shell structure in which a liquid L1 is encapsulated as a core C, and the core C is enclosed in a membrane HM. Since the core C contains the first substrate, the first substrate in the core C may react with the second substrate to solidify (gel) the core C.

### Ejection Unit

As illustrated in FIG. 1, the ejection unit 10 includes an ejection head 110 and a transport module 120.

### Ejection Head

The ejection head 110 employs a so-called inkjet format, the ejection head 110 ejecting the liquid L1 held therein to form a liquid droplet DR.

The “inkjet format” is a method for ejecting a liquid that is a material for liquid droplets from a nozzle of an ejection head with high precision, a small amount at a time. In an ejection head employing the inkjet format, energy created by pressure, inertial force, etc. is momentarily applied to the liquid stored in the ejection head. As a result, among the liquid in the ejection head, the portion near the nozzle separates in response to the applied energy, forming a minute liquid droplet.

The ejection unit 10 may include just one ejection head 110 or may include a plurality thereof. The ejection unit 10 illustrated in FIG. 1 includes three ejection heads 110a, 110b, 110c. The three ejection heads 110a, 110b, 110c are referred to collectively as an ejection unit 110L.

Each of the ejection heads 110a, 110b, 110c may have the same configuration or they may have configurations that are different from each other.

The three ejection heads 110a, 110b, 110c are arrayed in a direction (the x direction in the drawing) that intersects the liquid ejection direction (the −z direction in the drawing) in which the liquid is ejected from the ejection head 110.

As illustrated in FIG. 2, the ejection head 110 includes a liquid holding module 111, a vibration module 115 and a fixing structure 117.

A space surrounded by the liquid holding module 111 and the vibration module 115 is a liquid chamber 110S of the ejection head 110. The liquid chamber 110S holds the liquid L1 serving as the source for the liquid droplets DR.

The amount of the liquid L1 held in the liquid chamber 110S is not particularly limited. For example, the amount of the liquid L1 held in the liquid chamber 110S may be approximately 1 μL to 10 mL.

Each of the ejection heads 110a, 110b, 110c may hold the same liquid L1, or they may hold liquids L1 that are different from each other.

### Liquid Holding Module

The liquid holding module 111 is a tubular element that is open at both ends in the z direction. The liquid holding module 111 may preferably be a cylindrical element. For example, the material of the liquid holding module 111 may be a metallic material such as stainless steel, nickel, or aluminum; a plastic material (resin material) such as ABS, polycarbonate, or a fluororesin; a ceramic material such as silicon dioxide, alumina, or zirconia; silicon; etc. The liquid holding module 111 may be opaque, and may include a region that is optically transparent.

The lower end, which is one end of the liquid holding module 111, is closed by being covered by the vibration module 115. The upper end, which is the other end of the liquid holding module 111, is open to the atmosphere. When the liquid holding module 111 is open to the atmosphere in the upward direction, the liquid L1 held in the liquid holding module 111 at the time of ejection of the liquid droplet does not tend to become pressurized. Therefore, when the liquid L1 contains cells, damage to the cells can be suppressed.

The upper end of the liquid holding module may be partially covered by a lid in order to suppress evaporation of the dispersion medium in the liquid L1.

### Vibration Module

The vibration module (vibration actuator) 115 includes a nozzle plate (membranous element) 112 and a vibration unit 113. In the vibration module 115 illustrated in FIG. 2, the vibration unit 113 is located above and the nozzle plate 112 is located below. However, the configuration is not limited thereto, and the nozzle plate 112 may be above and the vibration unit 113 may be below.

### Nozzle Plate (Membranous Element)

The nozzle plate 112 is a membranous element having an ejection port 112x. The nozzle plate 112 closes the lower end of the liquid holding module 111. The nozzle plate 112 and the liquid holding module 111 form a liquid chamber 110S that holds the liquid L1. The ejection port 112x communicates with the liquid holding module 111.

The planar shape, the size in plain view, the material, and the structure of the nozzle plate 112 are not particularly limited, and can be selected, as appropriate, in accordance with the purpose.

For example, the planar shape of the outer edges of the nozzle plate 112 may be circular, elliptical, rectangular, square, diamond-shaped, etc. For example, if the shape of the outer edges of the nozzle plate 112 is circular, the nozzle plate 112 becomes a ring-shaped element.

When the nozzle plate 112 is too thick, it becomes difficult to vibrate; when the nozzle plate 112 is too thin, it tends to vibrate excessively, reducing the stability of the liquid droplet ejection. Therefore, the thickness of the nozzle plate 112 should preferably be at least 5 μm and at most 500 μm, more preferably at least 20 μm and at most 100 μm.

As one example, the nozzle plate 112 can be a circular element having a diameter of 20 mm and an average thickness of 0.05 mm.

The nozzle plate 112 is not supported on the end towards the ejection port 112x, and can vibrate up and down. When the end of the nozzle plate 112 near the ejection port 112x vibrates, it applies a downward force to the liquid L1 locates near the ejection port 112x, thereby ejecting the liquid L1 as a liquid droplet DR from the ejection port 112x.

As the material of the nozzle plate 112, if the material is too soft, the nozzle plate 112 easily vibrates and it is difficult to immediately suppress the vibrations when the liquid L1 is not being ejected. Therefore, a material with some degree of hardness is preferably used.

Additionally, when the liquid L1 to be ejected is a dispersion including cells as the sedimenting particles B, the material of the nozzle plate 112 is preferably a material with low cytotoxicity to which cells do not easily adhere. A material with high hydrophobicity is preferable as such a material.

For example, such materials include metals, ceramics, polymer materials, etc.

More specifically, examples of materials for the material of the nozzle plate 112 include metallic materials (e.g., stainless steel, nickel, aluminum), ceramic materials (e.g., silicon dioxide, alumina, zirconia), polymeric materials (e.g., ABS, polycarbonate, a fluororesin), etc. Furthermore, a composite material in which the surface of the nozzle plate 112 formed from a material different from the above-mentioned materials is coated with the above metallic materials, the above ceramic materials, or a synthetic phospholipid polymer (for example, Lipidure, manufactured by NOF Corp.) simulating a cell membrane can be used.

Regarding the number of arrayed ejection ports 112x, the form of the array, the spacing (pitch), the shapes of the openings, the size of the openings, etc., there are not particularly limited, and these can be selected, as appropriate, in accordance with the purpose.

The shapes of the openings of the ejection ports 112x can be selected, as appropriate, in accordance with the purpose. For example, the shapes of the openings of the ejection ports 112x may be circular, elliptical, rectangular, etc. In particular, the shapes of the openings of the ejection ports 112x are preferably circular.

The average opening diameter of the ejection ports 112x is not particularly limited and can be selected, as appropriate, in accordance with the purpose. To prevent clogging of the ejection ports 112x by sedimenting particles B dispersed in the liquid L1 to be ejected, the size of the openings of the ejection ports 112x should preferably be at least twice the maximum diameter of the sedimenting particles B.

When the sedimenting particles B are animal cells, particularly human cells, the average opening diameter of the ejection ports 112x should preferably be at least 10 μm and at most 1000 μm.

The sizes of human cells differ depending on the types of cells, being roughly between 5 μm and 50 μm. Additionally, in the case in which the sedimenting particles B are cell aggregates (for example, spheres, spheroids, organoids), the sizes of the cell aggregates are tens of μm to several mm. Therefore, to suppress clogging of the ejection ports 112x, the ports are set to the above-mentioned size and configured to have an average opening diameter appropriate for the cells to be ejected.

The ejection ports 112x can eject relatively larger cell aggregates when the opening diameter is large; however, as the diameter increases, stable ejection becomes difficult to achieve. By setting the average opening diameter of the ejection ports 112x to 1000 μm or less, a large number of cell aggregates can be ejected in a stable manner. For improved ejection stability, it is preferable that the average opening diameter of the ejection ports 112x be no greater than 700 μm.

Moreover, when the opening diameter of the ejection ports 112x is small, the cells or cell aggregates passing through them tend to experience higher shear stress. Accordingly, a larger average opening diameter of the ejection ports 112x is preferable.

As the positions of the ejection ports 112x in the nozzle plates 112, there is not particularly limited, and the positions can be selected, as appropriate, in accordance with the purpose. For example, they may be at the centers of the nozzle plates 112 in plain view or they may be at positions other than the centers of the nozzle plates 112 in plain view.

Additionally, there may be one or a plurality of ejection ports 112x in a nozzle plate 112. A nozzle plate 112 having a plurality of ejection ports 112x can be favorably employed in a cylindrical liquid holding module 111. In a nozzle plate 112 that is exposed to the internal space in the liquid holding module 111, the plurality of ejection ports 112x may be arranged equidistantly from a central axis. By using such an arrangement, in the nozzle plate 112, the vibration state becomes equal in each ejection port 112x, i.e., the amplitudes and the vibration modes in the plurality of ejection ports 112x become equal. Therefore, the conditions can be made the same in terms of whether or not liquid is ejected, the liquid droplet size, and the ejection speed at the time of ejection.

A liquid holding module in which a nozzle plate 112 having a plurality of ejection ports 112x can be employed is not limited to being cylindrical. If the vibration state of the nozzle plate 112 is equivalent across the plurality of ejection ports 112x, liquid holding modules of various shapes can be employed. For example, in the case of an elliptic cylindrical liquid holding module, if an ejection port is provided at each position overlapping a focal point in an xy cross-section (rectangle) of the liquid holding module, the amplitude and the vibration mode of the nozzle plate 112 may be equal at each ejection port. As a result, droplet presence, size, and ejection speed can be made consistent, enabling simultaneous ejection.

Similarly, when the liquid holding module has a square tubular shape, an xy cross-section is considered. Ejection ports are placed at arbitrary points in the cross-section, and additional ports are placed at positions symmetric to those points (line-symmetric or point-symmetric). This configuration ensures that the amplitudes and the vibration modes of the nozzle plate 112 at each ejection port are equivalent.

### Vibration Unit

The vibration unit 113 vibrates the nozzle plate 112 based on input electrical signals to eject a liquid droplet DR from the ejection port 112x.

The vibration unit 113 is mounted on the upper surface of the nozzle plate 112.

The shape, size, material, and structure of the vibration unit 113 are not particularly limited, and can be selected, as appropriate, in accordance with the purpose.

The shape and arrangement of the vibration unit 113 are not particularly limited as long as the effects of the invention are not compromised, and it can be designed, as appropriate, in accordance with the shape of the nozzle plate 112. For example, in the case in which the planar shape of the nozzle plate 112 is ring-shaped, the vibration unit 113 is preferably mounted concentrically around the ejection port 112x.

As examples of the vibration unit 113, there are piezoelectric elements and electromagnetic solenoids, and piezoelectric elements are preferably used. For example, piezoelectric elements may have a structure in which electrodes are provided for applying voltages to the upper surface and the lower surface of a piezoelectric material. By applying voltage between the upper and lower electrodes of the piezoelectric element from the control unit 50, compressive stress is generated in the lateral direction of the membrane surface, causing the nozzle plate 112 to vibrate vertically.

The piezoelectric material is not particularly limited and can be selected, as appropriate, in accordance with the purpose. For example, there are materials such as lead zirconate titanate (PZT), bismuth-iron oxides, metal niobates, barium titanate, or materials obtained by adding metals or different oxides to the above-mentioned materials, etc. Among the above, lead zirconate titanate (PZT) is preferable.

The vibration mode of the piezoelectric element is not particularly limited, and can be selected, as appropriate, in accordance with the purpose. For example, the vibration mode may be a vertical mode, a bending mode, etc. For example, as piezoelectric elements in the vertical mode, it is possible to use stacked type piezoelectric elements that are stacked in the z direction, the piezoelectric elements expanding in the vertical direction (z direction) and contracting in the horizontal direction (xy direction) when a voltage is applied.

Additionally, for example, as piezoelectric elements in the bending mode, it is possible to use bimorph-type piezoelectric elements that deform and bend so that the position of one end of the piezoelectric element is displaced when a voltage is applied.

### Fixing Structure

The fixing structure 117 is a tubular element surrounding the periphery of the liquid holding module 111. The fixing structure 117 holds the vibration module 115 at the lower end thereof. The fixing structure 117 is used to attach the ejection head 110 to the transport module 120.

The shape of the fixing structure 117 is not limited to being tubular, and various shapes can be employed as long as they can hold the vibration module 115 and can attach the ejection head 110 to the transport module 120.

When a prescribed electrical signal (voltage pulse) is applied to the vibration unit 113, in the vibration unit 113, a central portion that is not fixed to the fixing structure 117 deforms vertically. As a result of this deformation operation, localized pressure is applied to the liquid L1 near the nozzle plate 112 in the liquid chamber 110S, and a flow of the liquid L1 towards the ejection port 112x is generated. A portion of the liquid L1 forming this flow is ejected from the ejection port 112x as a liquid droplet.

In the production apparatus 1, as a result of the above-mentioned operation, there may not be situations in which a large pressure is applied to the entire liquid chamber, as in known inkjet heads having closed liquid chambers. Therefore, when ejecting a dispersion in which cells are dispersed, the cells in the dispersion tend not to be damaged, which is favorable.

Furthermore, the ejection head 110 may be provided with an extension element 119 at the upper end 111x of the liquid holding module 111. The extension element 119 extends at least part of the upper end 111x outward in the radial direction of the liquid holding module 111. The extension element 119 can be formed from the same material as the liquid holding module 111. Additionally, in the present example embodiment, the extension element 119 is described as being separate from the liquid holding module 111. However, the extension element 119 and the liquid holding module 111 may be integrated.

The extension element 119 may be provided so as to be ring-shaped in plain view, and so that the upper end 111x of the liquid holding module 111 extends (increases in diameter) towards the radially outer side around the entire circumference in the circumferential direction.

When liquid L1 from the supply apparatus 20A is supplied directly into the liquid L1 within the liquid chamber 110S, there can be assumed to be problems in which the liquid L1 splashes towards the periphery. Additionally, there is a risk that air bubbles may become mixed into the liquid L1 in the liquid chamber 110S, affecting the liquid droplet ejection state from inside the ejection head 110.

The “liquid droplet ejection state” refers to the manner of ejection of the liquid L1 by the ejection head 110, or to the state in which ejection is not possible. When the liquid droplet ejection state changes, there is a risk that the liquid droplets DR size ejected from the ejection head 110 may be affected. As a result, there is a risk of variation in droplet size between multiple liquid droplets DR. If the liquid droplets DR size is different, the amount of the dispersion medium (sedimenting particles) contained in a single liquid droplet naturally tends to differ between the multiple liquid droplets DR.

In contrast therewith, as a result of the liquid holding module 111 having the extension element 119, the liquid L1 supplied to the ejection head 110 from the supply apparatus 20A may tend not the splash to the periphery. Additionally, as illustrated in FIG. 2, by supplying the liquid L1 through the extension element 119 described above, air bubbles tend not to become mixed into the liquid L1 stored in the liquid chamber 110S. As a result, ejection defects of the ejection head 110 caused by air bubbles can be suppressed.

### Transport Module

The transport module 120 includes a first movement element 121 and a second movement element 122.

### First Movement Element

The first movement element 121 includes a supporting element 121a and a linear movement element 121b. The first movement element 121 is a pair of elements provided at the end of the second movement element 122 on the +x side and at the end on the −x side.

The supporting element 121a is a rectangular element in a field of view seen from the +y direction, and supports the second movement element 122.

The linear movement element 121b is a long element that is elongated in the z direction. The linear movement element 121b vertically moves the supporting element 121a in the z direction. For example, as the linear movement element 121b, a known linear actuator provided with a stepping motor as the drive source can be employed.

The first movement element 121 moves an ejection unit 110L supported by the second movement element 122 by moving the supporting element 121a in the z direction.

### Second Movement Element

The second movement element 122 includes a supporting element 122a and a linear movement element 122b.

The supporting element 122a is a rectangular element in a field of view seen from the +y direction, and supports the ejection unit 110L.

The linear movement element 122b is a long element that is elongated in the x direction. The linear movement element 122b moves the supporting element 122a horizontally in the x direction. Both ends of the linear movement element 122b are supported by the supporting element 121a of the first movement element 121.

As the linear movement element 122b, for example, a known linear actuator provided with a stepping motor as the drive source can be employed.

The second movement element 122 moves the ejection unit 110L supported by the supporting element 122a in the x direction by moving the supporting element 122a in the x direction.

### Supply Apparatus

A supply apparatus 20A is provided for each ejection head 110, and supplies the liquid L1 to the ejection head 110. The supply apparatus 20A includes a storage module 21A, a supply element 23, and an agitation unit 25.

### Storage Module

The storage module 21A is an element that extends in a direction transverse to the vertical direction (z direction) and that stores the liquid L1 to be supplied to the ejection head 110. The storage module 21A illustrated in FIG. 2 extends in a direction (x direction) orthogonal to the vertical direction. The storage module 21A may be cylindrical, yet is not limited thereto and may be elliptic cylindrical or square tubular. Additionally, a tubular storage module 21A may have an outer diameter that is fixed or may have an outer diameter that changes. In the case in which the outer diameter changes, it may gradually decrease or may gradually increase towards one end, or may have a shape in which there is a change in the outer diameter in a portion thereof, forming recesses and protrusions.

The storage module 21A includes a storage module body 21 that stores the liquid L1, and a flow passage element 22A provided at one end of the storage module body 21 in the direction of the central axis AR. The flow passage element 22A may be cylindrical, yet is not limited thereto and may be elliptic cylindrical or square tubular. Additionally, the tubular storage module 21A may have an outer diameter that is fixed or may have an outer diameter that changes. In the case in which the outer diameter changes, it may gradually decrease or may gradually increase towards one end, or may have a shape in which there is a change in the outer diameter in a portion thereof, forming recesses and protrusions.

For example, as the storage module 21A, a syringe piston can be employed.

The flow passage element 22A is a pipe connected to the storage module body 21. As the flow passage element 22A, an element generally used in biochemical experiments, for which adverse effects on biomaterials have not been substantially confirmed. For example, the flow passage element 22A can employ glass tube, a resin pipe, a rubber tube, etc.

The tip portion of the flow passage element 22A is distanced from the liquid holding module 111, and a tip 22x of the flow passage element 22A is arranged to planarly overlap an opening portion at the upper end of the liquid holding module 111. As a result, the liquid L1 supplied from the storage module 21A is dripped into the liquid chamber 110S from above the liquid holding module 111.

### Supply Element

The supply element 23 discharges the liquid L1 inside the storage module 21A from one end (the tip 22x of the flow passage element 22A) of the storage module 21A in the central axis AR direction to supply the liquid L1 to the ejection head 110. For example, as the supply element 23 can employ a plunger. It uses simultaneously with the storage module 21A, which is a syringe piston.

The movement of the supply element 23 in the central axis AR direction is controlled by a drive apparatus, which is not illustrated. As such a drive apparatus, a known syringe pump can be employed.

As the supply element 23, a pump, which is not illustrated, may also be employed. In this case, the liquid L1 that is pushed out by the pump (supply element) is supplied to the ejection head 110 through the storage module 21A. In the case in which cells are spheroids are used as the sedimenting particles B, a plunger is preferably employed as the supply element 23 in order to avoid damaging the cells by the action of the pump.

### Agitation Unit

The agitation unit 25 rotates the storage module 21A in the circumferential direction about the central axis AR of the storage module 21A. As a result, the liquid L1 inside the storage module 21A flows and is agitated inside the storage module 21A.

The agitation unit 25 can make the storage module 21A rotate in various patterns. For example, the rotation speed and rotation direction of the storage module 21A due to the agitation unit 25 may be fixed or may be changed. To “change the rotation direction” means to switch the rotation direction between a forward direction and a reverse direction.

In the case in which both the rotation speed and the rotation direction are to be changed, they may be changed periodically, intermittently, or randomly. Additionally, they may be changed in accordance with prescribed criteria, such as the amount of liquid stored in the liquid holding module 111. As these changes, configurations that are suitable for a suspension being used can be selected.

The agitation unit 25 includes a motor 251, a motor shaft 252 for transmitting the rotational action of the motor 251, a pulley 253 provided on the motor shaft 252, and a belt 254 looped around the pulley 253 and the storage module 21A.

When the motor 251 is driven, the rotational action is transmitted to the pulley 253 by the motor shaft 252. When the pulley 253 rotates, the rotational action is transmitted to the storage module 21A by the belt 254, and the storage module 21A rotates in the circumferential direction about the central axis AR.

The outer surface of the storage module 21A (storage module body 21) is preferably provided with a pulley element on which the belt 254 is looped.

Additionally, the agitation unit 25 includes a supporting element 255 that rotatably supports the storage module 21A. For example, as the supporting element 255, a known ball bearing can be employed. A supporting element 255 that is a ring-shaped ball bearing can be made to support the storage module 21A by inserting the storage module 21A in a hole.

The agitation unit 25 illustrated in the drawing connects the motor shaft 252 with the storage module 21A by using the pulley 253 and the belt 254, and thereby transmits the rotational action, yet is not limited to this configuration. For example, a chain may be used instead of the belt 254, gears that mesh with each other may be provided on the motor shaft 252 and on the outer surface of the storage module 21A, and the rotational action may be transmitted by the gears. Additionally, the storage module 21A may be placed above a roller, and the roller can be rotated by using a gear, etc. to rotate the storage module 21A.

### Droplet Landing Element

The droplet landing element 30 is an element disposed in the ejection direction of the liquid droplets DR, on which the liquid droplets DR land. The droplet landing element 30 is a container that stores the liquid L2 containing the second substrate and that opens upward (+z direction). For example, as the droplet landing element 30, either a shallow container such as a petri dish or a deep container such as a beaker may be used.

The material of the droplet landing element 30 is no particular limitation, and an organic material such as a synthetic resin, an inorganic material such as glass, a metal material, etc. can be employed as appropriate.

The droplet landing element 30 may have an agitation apparatus that agitates the stored liquid L2. As a result, sedimentation and aggregation of microcapsules MC formed in the liquid L2 can be suppressed. As the agitation apparatus, a known configuration can be employed.

### Placement Module

The droplet landing element 30 is placed on the placement module 40. The placement module 40 includes an x-stage 41, a y-stage 42, and a base 43.

The x-stage 41 supports and fixes the droplet landing element 30. Additionally, the x-stage 41 moves the droplet landing element 30 horizontally in the x direction.

The y-stage 42 moves the x-stage 41 horizontally in the y direction.

The base 43 supports the y-stage 42.

As the placement module 40, a known configuration for xy stages can be employed. The placement module 40 may be an xyz stage that can be moved in the z direction also. In order for the liquid L1 ejected from the ejection head 110 to form liquid droplets DR, there must be at least a certain distance between the ejection head 110 and the liquid surface of the liquid L2. In the case in which a large amount of liquid droplets DR are ejected, there is a risk that the liquid surface of the liquid L2 may rise until the above-mentioned “at least a certain distance” cannot be ensured. Therefore, the distance between the ejection head 110 and the liquid surface of the liquid L2 can be appropriately controlled to move the droplet landing element 30 in the z direction by means of the z-stage as the liquid surface of the liquid L2 rises.

### Control Unit

The control unit 50 prepares electrical signals for operating the respective portions of the production apparatus 1, and controls the respective portions by supplying the electrical signals thereto. The control unit 50, for example, prepares drive signals to be supplied to the ejection unit 10, the supply apparatus 20A, the placement module 40, and the transport module 120, and supplies the drive signals to the respective portions to control the operation of the respective portions.

### Other Features

Aside from the above, the production apparatus 1 may include a detection apparatus 60 that detects the ejection of a liquid droplet DR by the ejection head 110. For example, as the detection apparatus 60, it is possible to employ a light source 61 and a light reception module 62. The light source 61 emits a laser beam L used for detection on the flight path on which the liquid droplets DR ejected from the ejection head 110 fly. The light reception module 62 for receiving the laser beam L. With such a detection apparatus 60, when a liquid droplet DR blocks the laser beam L, the laser beam L stops being detected by the light reception module 62. Therefore, the ejection of liquid droplets DR can be detected.

Although the detection apparatus 60 was described as detecting liquid droplets DR in flight by using a laser beam L, there is no limitation thereto. An image capture apparatus can be employed as the detection apparatus 60, and liquid droplets DR can be detected by observing the liquid droplets DR in flight.

Aside from the above, the placement module 40 can be configured to be able to detect mass, and the ejection of liquid droplets DR can be detected by comparing the ejection timing of liquid droplets DR by the ejection head 110 with the change in mass detected in the placement module 40.

As illustrated in FIG. 3, the production apparatus 1 may include liquid amount measurement modules 71, 72 that measure the amount of liquid L1 stored in the liquid chamber 110S of the ejection head 110. Although liquid amount measurement modules 71, 72 are illustrated in FIG. 3, there may be just one of them.

The liquid amount measurement module 71 is a known liquid surface sensor that detects the liquid surface LS of the liquid L1 in the liquid chamber 110S. The liquid amount measurement module 71 emits a laser beam L for use in measurement towards the liquid surface LS from above the liquid holding module 111, and detects the position of the liquid surface LS by detecting reflected light from the laser beam L on the liquid surface LS. A float for detection that reflects the laser beam L may be floated on the liquid surface of the liquid L1.

The liquid amount measurement module 72 is an image capture apparatus having the liquid surface LS contained within the field of view thereof. When employing the liquid amount measurement module 72, images can be captured by the liquid amount measurement module 72 by configuring the liquid holding module 111 to at least partially transmit light.

The liquid amount measurement module is not limited to the above-mentioned configuration, and a known liquid surface meter can be employed.

The control unit 50 may control the operations of the supply apparatus 20A based on measurement results by the liquid amount measurement modules 71, 72. That is, when the amount of the liquid L1 in the liquid chamber 110S has reached a preset supply criterion, based on the measurement results by the liquid amount measurement modules 71, 72, the control unit 50 may operate the supply apparatus 20A to supply the liquid L1 to the ejection head 110.

That is, the liquid L1 can be supplied to the ejection head 110 by the supply apparatus 20A either continuously or intermittently. In the case in which the liquid L1 is supplied intermittently, it may be supplied based on measurement results as mentioned above, or a fixed amount may be supplied periodically.

### Method for Producing Shaped Body Containing Sedimenting Particles

The method for producing a shaped body containing sedimenting particles of the present embodiment, as one example, can be favorably implemented by using the above-mentioned production apparatus 1. The method for producing a shaped body containing sedimenting particles involves a step of supplying a liquid L1 containing sedimenting particles B from a supply apparatus 20A storing the liquid L1 to an inkjet-type ejection head 110, and a step of ejecting the liquid L1 from the ejection head 110 as a liquid droplet DR to form a shaped body (microcapsule MC) containing the sedimenting particles in a droplet landing element 30 disposed in a direction of ejection of the liquid droplet DR.

The supply apparatus 20a includes a storage module 21A that stores the liquid L1 and supplies the liquid L1 to the ejection head 110 from one end of the storage module 21A in the direction of the central axis AR.

In the supplying step, the liquid L1 is supplied to the ejection head 110, the liquid L1 being agitated by rotating the storage module 21A in a circumferential direction about a central axis AR of the storage module 21A.

In the forming step, the agitated liquid L1 is ejected as the liquid droplet DR.

In the production apparatus and the method for producing a shaped body containing sedimenting particles as described above, the liquid L1 is supplied to the ejection head 110 after agitating the liquid L1. By ejecting the liquid L1 without allowing prolonged stagnation in the ejection head 110, the sedimentation of the sedimenting particles B in the ejection head 110 can be suppressed.

Additionally, since the agitation of the liquid L1 is performed in the supply apparatus 20A, the agitation operation of the liquid L1 may not affect the ejection operation of the ejection head 110. Therefore, the ejection head 110 can continuously and stably eject the liquid L1.

Furthermore, even in the case in which a large amount of the liquid L1 is to be continuously ejected, the liquid chamber 110S in the ejection head 110 does not need to be provided with a large capacity due to the liquid L1, which has been agitated in the supply apparatus 20A and in which the sedimenting particles B have been suitably dispersed, being supplied continuously to the ejection head 110.

As a result, the production apparatus for a shaped body containing sedimenting particles and the method for producing a shaped body containing sedimenting particles as described above, shaped bodies containing sedimenting particles containing a fixed amount of sedimenting particles (i.e., of uniform quality) can be continuously mass-produced.

In the present embodiment, examples in which the liquid holding module 111 is square tubular or cylindrical with the same cross-section have been described. However, it may be conical or funnel-shaped such that the inner diameter gradually decreases in the downward direction (the inner diameter gradually increases in the upward direction). When the liquid L1 is directly supplied from the supply apparatus 20A to the liquid chamber 110S, the liquid droplets of the liquid L1 that have parted from the tip 22x drop into the liquid L1 in the liquid holding module 112x. At this time, if the tip 22x of the supply passage element 22A is disposed at a position directly above the ejection port 112x, there is a risk that a liquid droplet that has dropped into the liquid L1 in the liquid holding module 111 may apply downward pressure on the liquid L1 near the ejection port 112x, thereby affecting the ejection state of the liquid droplets DR ejected from the ejection head 110.

In contrast therewith, by making the liquid holding module 111 conical or funnel-shaped, the liquid L1 can be supplied near a side wall at the upper end of the enlarged-diameter liquid holding module 111 rather than directly above the ejection port 112x, thereby suppressing the impact on the ejection state as mentioned above.

Additionally, in an inkjet-type ejection apparatus, it is generally important to suppress fluctuations in the hydrostatic pressure at ejection holes, i.e., the liquid height of the liquid holding module, in order to stabilize the ejection state. By making the liquid holding module 111 conical or funnel-shaped, consumption of the liquid L1 by the ejection of liquid droplets and fluctuations in the liquid surface height in the liquid holding module 111 associated with the supply of liquid L1 to the liquid holding module 111 can be reduced. As a result, the stability of the ejection state can be increased.

Additionally, in the production apparatus 1 of the present embodiment, the tip portion of the flow passage element 22A of the supply apparatus 20A is distanced from the liquid holding module 111. However, there is no limitation thereto.

FIG. 4 is a diagram for describing a production apparatus 2 of a modified example. A supply apparatus 20B provided in the production apparatus 2 includes a storage module 21B having a storage module body 21 and a flow passage element 22B. In the production apparatus 2, an outer surface of the flow passage element 22B contacts an upper end of the liquid holding module 111.

In the case of this configuration, if the flow passage element 22B (storage module 21B) constrains movement of the ejection head 110 by means of the liquid holding module 111, the operations of the vibration element 113 are restricted. As a result, there is a risk of the membranous element 112 not vibrating as desired at the ejection head 110, causing problems in the ejection of liquid droplets DR.

In response to such issues that can be contemplated, the flow passage element 22B is formed from a soft resin material such as silicone rubber. As a result, the flow passage element 22B deforms in synchronization with vibrations that have been generated by the vibration element 113 and transmitted to the storage module 21B through the liquid holding module 111. Therefore, such a flow passage element 22B does not constrain movement of the ejection head 110 and does not inhibit the ejection of the liquid droplets DR. The flow passage element 22B corresponds to a synchronization structure in the present invention.

The synchronization structure in the supply apparatus 20B is not limited to the flow passage element 22B mentioned above. For example, the supply apparatus 20B may include a gimbal supporting the storage module 21B. The gimbal moves the storage module 21B in synchronization with vibrations transmitted to the storage module 21B to hold the relative positions of the storage module 21B and the ejection head 110 fixed. As a result, the flow passage element 22B does not constrain the movement of the ejection head 110 and does not inhibit the ejection of the liquid droplets DR.

### Second Embodiment

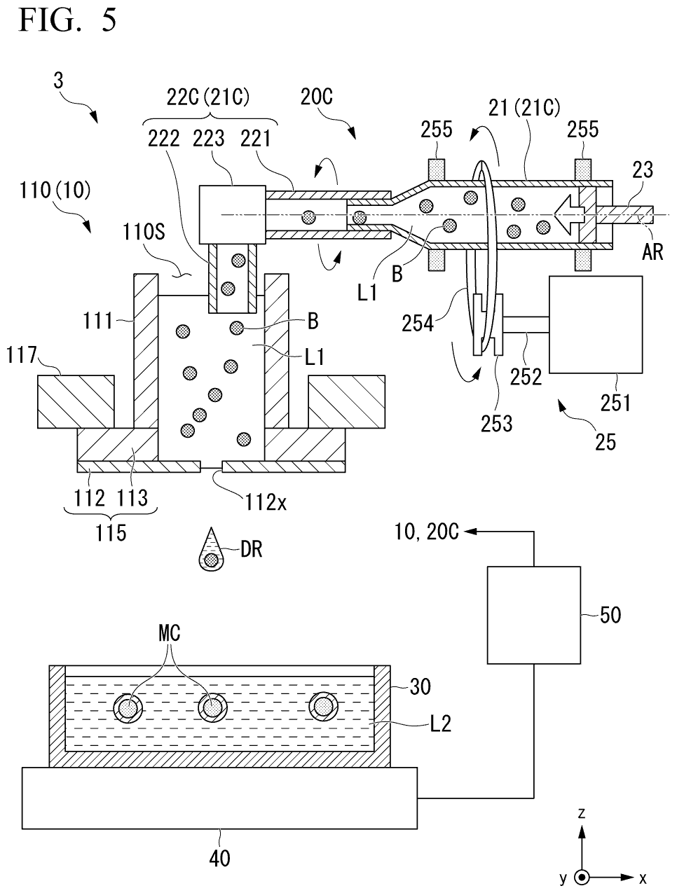

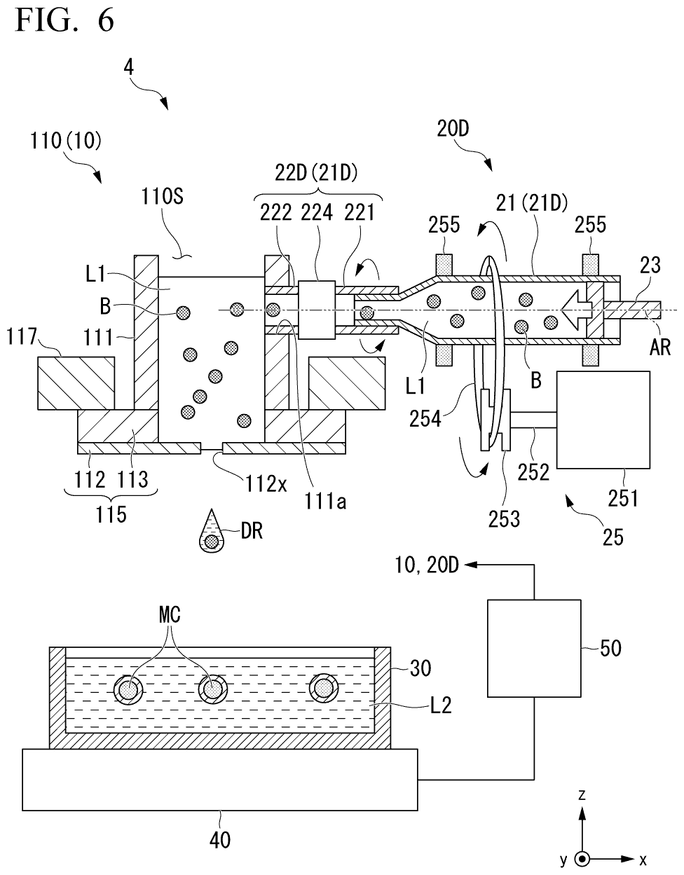

FIGS. 5 and 6 are diagrams for describing the production apparatus for a shaped body containing sedimenting particles of a second embodiment. In the present embodiment, the constituent elements that are common to those in the first embodiment may be assigned the same reference numbers, and detailed explanations may be omitted.

The production apparatus 3 illustrated in FIG. 5 includes an ejection unit 10, a supply apparatus 20C, a droplet landing element 30, a placement module 40, and a control unit 50.

The supply apparatus 20C includes a storage module 21C, a supply element 23, and an agitation unit 25. The storage module 21C includes a storage module body 21 that stores the liquid L1, and a flow passage element 22C provided on one end of the storage module body 21 in the direction of the central axis AR.

The flow passage element 22C is a pipe connected to the storage module body 21. The flow passage element 22C includes a tubular first element 221 connected to the storage module body 21, a tubular second element 222 constituting the tip of the flow passage element 22C, and a connection element 223 connecting the first element 221 and the second element 222.

The first element 221 and the second element 222 can employ configurations similar to those of the flow passage elements 22A, 22B mentioned above.

The connection element 223 is a rotary joint that can rotate the first element 221 and the storage module body 21 independently of the second element 222.

The flow passage element 22C is bent at the connection element 223. The second element 222 extends vertically downward (z direction) from the connection element 223. The tip of the second element 222 is inserted in an interior space (liquid chamber 110S) of the liquid holding module 111 through an opening in the upper end of the liquid holding module 111.

In the production apparatus 3, the liquid amount of the liquid L1 inside the liquid chamber 110S is controlled to maintain a state in which the tip of the second element 222 (the tip of the storage module 21C) is positioned below the liquid surface of the liquid L1. Such control can be easily implemented by, for example, using the liquid amount measurement modules 71, 72 mentioned above to check the liquid surface position.

In such a production apparatus 3, the liquid L1 can be directly supplied from the supply apparatus 20C below the liquid surface in the liquid chamber 110S. As a result, when supplying the liquid L1 to the ejection head 110 from the supply apparatus 20C, the splashing of the liquid L1 to the periphery can be suppressed. Additionally, by supplying the liquid L1 directly below the liquid surface in the liquid chamber 110S, air bubbles tend not to become mixed into the liquid L1. As a result, ejection defects of the ejection head 110 caused by air bubbles can be suppressed.

The production apparatus 4 illustrated in FIG. 6 includes an ejection unit 10, a supply apparatus 20D, a droplet landing element 30, a placement module 40, and a control unit 50.

The supply apparatus 20D includes a storage module 21D, a supply element 23, and an agitation unit 25. The storage module 21D includes a tubular storage module body 21 that stores the liquid L1, and a tubular flow passage material 22D provided at one end of the storage module body 21 in the direction of the central axis AR.

The flow passage element 22D is a pipe connected to the storage module body 21. The flow passage element 22D includes a first element 221, a second element 222, and a connection element 224 connecting the first element 221 and the second element 222.

The connection element 224 is a rotary joint that can rotate the first element 221 and the storage module body 21 independently of the second element 222. The connection element 224 connects the first element 221 and the second element 222 coaxially.

The second element 222 detachably fits into a through-hole 111a provided on a side wall of the liquid holding module 111 and is connected with the liquid holding module 111. The second element 222 is formed from a soft resin material such as silicone rubber. The second element 222 corresponds to a synchronization structure in the present invention.

In the production apparatus 4, the liquid amount of the liquid L1 inside the liquid chamber 110S is controlled to maintain a state in which the liquid surface of the liquid L1 is positioned higher than the through-hole 111a. Such control can be easily implemented by, for example, using the liquid amount measurement modules 71, 72 mentioned above to check the liquid surface position.

In such a production apparatus 4 also, the liquid L1 can be directly supplied from the supply apparatus 20D below the liquid surface in the liquid chamber 110S. As a result, when supplying the liquid L1 to the ejection head 110 from the supply apparatus 20D, the splashing of the liquid L1 to the periphery can be suppressed. Additionally, by supplying the liquid L1 directly below the liquid surface in the liquid chamber 110S, air bubbles tend not to become mixed into the liquid L1. As a result, ejection defects of the ejection head 110 caused by air bubbles can be suppressed.

Furthermore, by forming the second element 222 with a soft resin material, the second element 222 deforms in synchronization with vibrations that have been generated by the vibration element 113 and transmitted to the storage module 21D through the liquid holding module 111. As a result, the flow passage element 22D does not constrain the movement of the ejection head 110 and does not inhibit the ejection of the liquid droplets DR.

As with the production apparatus 2 described above, the synchronization structure in the supply apparatus 20D may be a gimbal supporting the storage module 21D instead of the second element 222 described above. As a result, the flow passage element 22D does not constrain the movement of the ejection head 110 and does not inhibit the ejection of the liquid droplets DR.

As a result of the production apparatuses 3, 4 above also, sedimentation of the sedimenting particles B in the ejection head 110 can be suppressed, and the liquid L1 can be continuously and stably ejected from the ejection head 110. As a result, shaped bodies containing sedimenting particles of uniform quality can be continuously mass-produced.

### Third Embodiment

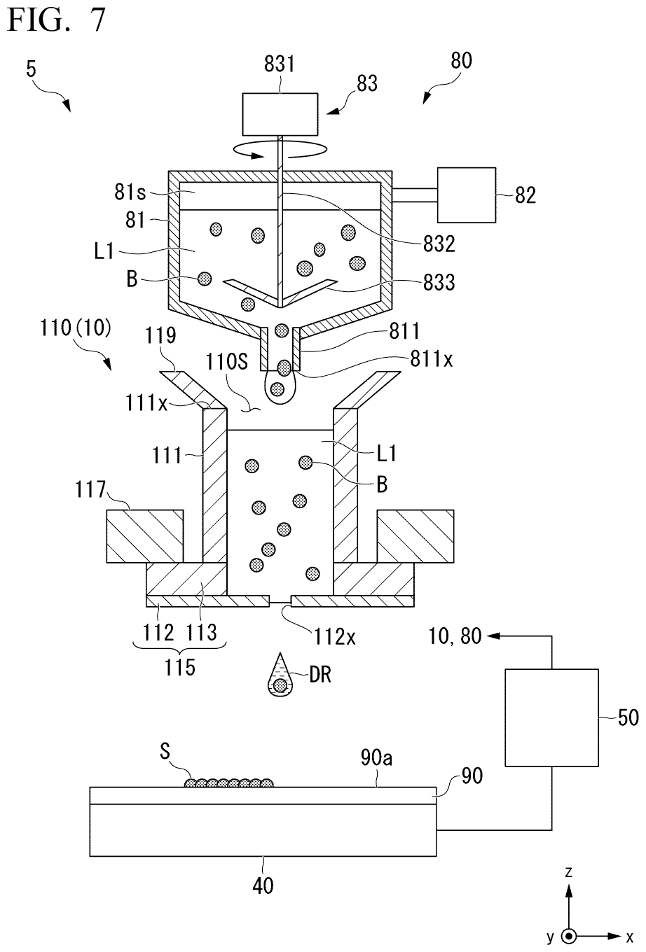

FIG. 7 is a diagram for describing a production apparatus for a shaped body containing sedimenting particles of a third embodiment. In the present embodiment, the constituent elements that are common to those in the second embodiment may be assigned the same reference numbers, and detailed explanations may be omitted.

The production apparatus 5 illustrated in FIG. 7 includes an ejection unit 10, a supply apparatus 80, a droplet landing element 90, a placement module 40, and a control unit 50.

The supply apparatus 80 includes a storage module 81, a supply element 82, and an agitation element 83.

The storage module 81 is disposed vertically above a liquid chamber 110S in the ejection head 110 and stores a liquid L1.

The storage module 81 is a tank that is sealed with respect to the atmosphere. The lower portion of the storage module 81 illustrated in FIG. 7 is formed with a conical shape with an inner diameter that gradually decreases. A through-hole is formed in the lower end of the storage module 81 and a pipe 811 connecting the inside and the outside of the storage module 81 is connected thereto. The lower end of the pipe 811 is a supply port 811x of the storage module 81. The shape of the storage module 81 is not limited thereto, and a known liquid tank having a supply port at the lower end thereof can be employed.

The supply element 82 is a pressure control apparatus that adjusts the gas pressure of a gas phase section 81s in the storage module 81. By depressurizing the gas phase section 81s, the supply module 82 prevents leakage of the liquid L3 from the supply port 811x and holds the liquid L3 in the storage module 81. Additionally, the supply module 82 supplies (discharges) the liquid L3 from the supply port 71x by pressurizing the gas phase section 81s.

The agitation unit 83 agitates the liquid L1 inside the storage module 81. The agitation unit 83 includes a motor 831, a shaft 832 that transmits the rotational action of the motor 831, and agitation blades 833 provided at the lower end of the shaft 832. By driving the agitation unit 83, the liquid L1 inside the storage module 81 is agitated. When doing so, the agitation speed should preferably be as low as possible within a range in which the effects of the agitation can be obtained, so as not to damage the precipitating particles B.

In this case, by making the pipe 811 of the storage module 81 as short and as thick as possible, the flow of the liquid L1 formed by the agitation unit 83 is transmitted to the inside of the pipe 811, thereby increasing the agitation efficiency.

A deposition element 90 is a plate that is held on the placement module 40, which is an xy stage, such that the liquid droplets DR are deposited on the plate. The deposition element 90 may be a container having an upper portion that is open. The deposition element 90 corresponds to the droplet landing portion in the present invention.

The liquid droplets DR ejected from the ejection head 110 land on the deposition element 90. A shaped body S can be formed by further supplying a gelling agent (second substrate) to the liquid droplets DR on the deposition element 90 from an ejection head that is not illustrated. The biomaterials (precipitating particles B) contained in the liquid droplets DR connect with each other in the planar direction at the surface 90a of the deposition element 90 and are further stacked to form the shaped body S.

The surface 90a of the deposition element 90 may be surface-treated so that the precipitating particles B (shaped body S) can be more easily deposited.

Furthermore, the ejection unit 10 (ejection head 110) illustrated in FIG. 7 is provided at the upper end 111x of the liquid holding module 111, and includes an extension element 119 in which at least part of the upper end 111x of the liquid holding module 111 extends radially outward from the liquid holding module 111. As a result, ejection defects of the ejection head 110 caused by air bubbles can be suppressed.

### Production Method of Shaped Body Containing Sedimenting Particles

The method for producing a shaped body containing sedimenting particles of the present embodiment can be favorably implemented, as one example, by using the production apparatus 5 described above. The method for producing the shaped body containing sedimenting particles includes a step of supplying a liquid L1 containing a biomaterial, which consists of sedimenting particles B, from a supply apparatus 20A storing the liquid L1 to an inkjet-type ejection head 110, and a step of ejecting the liquid L1 from the ejection head 110 as a liquid droplet DR to form a shaped body S containing the sedimenting particles in a droplet landing portion (deposition element 90) disposed in a direction of ejection of the liquid droplet DR.

The supply apparatus 80 includes a storage module 81 that is disposed vertically above the ejection head 110, that stores the liquid L1, and that supplies the liquid L1 to the ejection head 110 from a supply port 811x in the lower end thereof.

In the supplying step, the liquid L1, which has been agitated in the storage module 81, is supplied to the ejection head 110.

In the forming step, the agitated liquid L1 is ejected as the liquid droplet DR.

In the deposition element 90, a shaped body S can be formed by supplying a gelling agent (second substrate) to the liquid L1 that has been ejected. An example of a method for supplying the gelling agent is a method of using an ejection head that is not illustrated to eject liquid droplets containing the gelling agent onto the liquid L1 deposited on the deposition element 90.

In the production apparatus 5 and the method for producing a shaped body containing sedimenting particles as described above, the sedimentation of the sedimenting particles B in the ejection head 110 can be suppressed, and the liquid L1 can be continuously and stably ejected from the ejection head 110. As a result, shaped bodies containing sedimenting particles of uniform quality can be continuously mass-produced.

While preferred example embodiments of the present invention have been described above with reference to the attached drawings, the present invention is not limited to these examples. The shapes, the combinations, etc. of the respective constituent elements indicated in the examples described above are exemplary, and can be variously modified based on design demands, etc., within a range not departing from the spirit of the present invention.

For example, in the production apparatuses 1-5 for a shaped body containing sedimenting particles described above, the control unit 50 may be connected to a server through a wired or wireless connection. The server may be placed inside a facility in which the production apparatus 1-5 is placed, may be placed in a facility managed by the manufacturer of the production apparatus 1-5, or may be installed on a cloud network.

Additionally, the control unit 50 may be configured to allow shaping results for shaped bodies shaped under production conditions that are set at the time of use to be input in association with said production conditions.

In the case of a configuration as described above, the production apparatuses 1-5 should preferably be able to upload, to the server, the production conditions for the shaped bodies that are set at the time of use and the production results for the shaped bodies under said production conditions. Additionally, the production apparatuses 1-5 should preferably be able to download, from the server, production conditions that were set when using the production apparatuses 1-5 in a different environment by another user, and the production results under said production conditions. The production conditions that can be uploaded and downloaded include not only conditions in which favorable shaped bodies were obtained, but also conditions in which favorable shaped bodies were not obtained.

By allowing information regarding production conditions and production results to be shared by multiple production apparatuses 1-5 via a server, the users of the production apparatuses 1-5 can easily obtain production conditions that are favorable for desired shaped bodies, allowing desired shaped bodies to be easily produced without performing a lot of trial and error.

The present invention includes the embodiments indicated below.
[1] A production apparatus for a shaped body containing sedimenting particles, the apparatus being provided with: an ejection head that ejects a liquid containing sedimenting particles, as a liquid droplet, onto a droplet landing element; and a supply apparatus that supplies the liquid to the ejection head; wherein the supply apparatus includes a storage module that extends in a direction transverse to the vertical direction and that stores the liquid, a supply module that supplies the liquid in the storage module from one end in a central axis direction of the storage module, and an agitation unit that rotates the storage module in a circumferential direction about the central axis of the storage module to agitate the liquid inside the storage module.
[2] The production apparatus for a shaped body containing sedimenting particles according to [1], wherein the storage module includes a storage module body that stores the liquid, and a flow passage element provided at one end of the storage module body in the central axis direction.
[3] The production apparatus for a shaped body containing sedimenting particles according to [2], wherein the flow passage element includes a first element connecting with the storage module body, a second element forming a tip of the flow passage element, and a connection element that connects the first element with the second element, wherein the connection element is a rotary joint that can rotate the first element and the storage module body independently of the second element.
[4] The production apparatus for a shaped body containing sedimenting particles according to [3], wherein the flow passage element is bent in the connection element, the ejection head includes a liquid holding module having an upper end that is open, and the liquid is supplied from the tip of the second element to the liquid holding module.
[5] The production apparatus for a shaped body containing sedimenting particles according to [2], wherein the ejection head includes a liquid holding module having an upper end that opens upward, and a tip of the flow passage element is arranged to planarly overlap with an opening in the upper end.
[6] The production apparatus for a shaped body containing sedimenting particles according to any one of [1] to [5], having a liquid amount measurement module that measures an amount of the liquid stored in the ejection head, and a control unit that controls operations of the supply apparatus based on measurement results by the liquid amount measurement module.
[7] The production apparatus for a shaped body containing sedimenting particles according to any one of [1] to [6], having a detection apparatus that detects ejection of the liquid droplet by the ejection head.
[8] The production apparatus for a shaped body containing sedimenting particles according to any one of [1] to [7], having as the droplet landing element, a deposition element at which the liquid droplet is deposited, and an xy stage that moves the deposition element in a horizontal direction.
[9] The production apparatus for a shaped body containing sedimenting particles according to any one of [1] to [8], wherein the ejection head includes a liquid holding module, a membranous element that includes an ejection port from which the liquid droplet is ejected, and that together with the liquid holding module, holds the liquid, and a vibration element that vibrates the membranous element.
[10] The production apparatus for a shaped body containing sedimenting particles according to [9], wherein an extension element having a shape in which at least part of an upper end of the liquid holding module extends to the outer side of the liquid holding module is provided on an upper end of the liquid holding module.
[11] A method for producing a shaped body containing sedimenting particles, the production method having: a step of supplying a liquid containing sedimenting particles from a supply apparatus storing the liquid to an inkjet-type ejection head; and a step of ejecting the liquid from the ejection head as a liquid droplet to form a shaped body containing the sedimenting particles in a droplet landing element disposed in a direction of ejection of the liquid droplet; wherein the supply apparatus includes a storage module that stores the liquid and supplies the liquid to the ejection head from one end of the storage module in a central axis direction, in the supplying step, the liquid is supplied to the ejection head, the liquid being agitated by rotating the storage module in a circumferential direction about a central axis of the storage module, and in the forming step, the agitated liquid is ejected as the liquid droplet.
[12] The method for producing a shaped body containing sedimenting particles according to [11], wherein the shaped body contains a hydrogel obtained by a first substrate and a second substrate reacting, the liquid contains one of the first substrate and the second substrate, and the droplet landing element includes the other of the first substrate and the second substrate.
[13] The method for producing a shaped body containing sedimenting particles according to [11] or [12], wherein the sedimenting particles are a biomaterial.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1, 2, 3, 4, 5 Production apparatus
20A, 20B, 20C, 20D, 80 Supply apparatus
21 Storage module body
21A, 21B, 21C, 21D, 81 Storage module
22A, 22B, 22C, 22D Flow passage element
22x Tip
23, 82 Supply element
25, 83 Agitation unit
30 Droplet landing element
40 Placement module (xy stage)
50 Control unit
60 Detection device
71, 72 Liquid amount measurement module
71x, 811x Supply port
90 Deposition element (droplet landing element)
110, 110a Ejection head
110S Liquid chamber
111 Liquid holding module
111a Through-hole
111x Upper end
112 Nozzle plate (membranous element)
112x Ejection port
113 Vibration element
115 Vibration module
119 Extension element
221 First element
222 Second element
223, 224 Connection element
S Shaped body
AR Central axis
B Sedimenting particle
DR Liquid droplet
HM Membrane
L1, L2 Liquid

### RELATED ART DOCUMENT

### Patent Document

Patent Document 1: JP 7187786 B

What is claimed is:

1. A production apparatus for a shaped body containing sedimenting particles, the apparatus being provided with:
an ejection head that ejects a liquid containing sedimenting particles, as a liquid droplet, onto a droplet landing element; and
a supply apparatus that supplies the liquid to the ejection head;
wherein the supply apparatus includes
a storage module that extends in a direction transverse to the vertical direction and that stores the liquid,
a supply module that supplies the liquid in the storage module from one end in a central axis direction of the storage module, and
an agitation unit that rotates the storage module in a circumferential direction about the central axis of the storage module to agitate the liquid inside the storage module.

2. The production apparatus for a shaped body containing sedimenting particles according to claim 1, wherein the storage module includes
a storage module body that stores the liquid, and
a flow passage element provided at one end of the storage module body in the central axis direction.

3. The production apparatus for a shaped body containing sedimenting particles according to claim 2, wherein the flow passage element includes
a first element connecting with the storage module body,
a second element forming a tip of the flow passage element, and
a connection element that connects the first element with the second element,
wherein the connection element is a rotary joint that can rotate the first element and the storage module body independently of the second element.

4. The production apparatus for a shaped body containing sedimenting particles according to claim 3, wherein
the flow passage element is bent in the connection element,
the ejection head includes a liquid holding module having an upper end that is open, and
the liquid is supplied from the tip of the second element to the liquid holding module.

5. The production apparatus for a shaped body containing sedimenting particles according to claim 2, wherein
the ejection head includes a liquid holding module having an upper end that opens upward, and
a tip of the flow passage element is arranged to planarly overlap with an opening in the upper end.

6. The production apparatus for a shaped body containing sedimenting particles according to claim 1, having
a liquid amount measurement module that measures an amount of the liquid stored in the ejection head, and
a control unit that controls operations of the supply apparatus based on measurement results by the liquid amount measurement module.

7. The production apparatus of a shaped body containing sedimenting particles according to claim 1, having a detection apparatus that detects ejection of the liquid droplet by the ejection head.

8. The production apparatus for a shaped body containing sedimenting particles according to claim 1, having
as the droplet landing element, a deposition element at which the liquid droplet is deposited, and
an xy stage that moves the deposition element in a horizontal direction.

9. The production apparatus for a shaped body containing sedimenting particles according to claim 1, wherein
the ejection head includes
a liquid holding module,
a membranous element that includes an ejection port from which the liquid droplet is ejected, and that together with the liquid holding module, holds the liquid, and
a vibration unit that vibrates the membranous element.

10. The production apparatus for a shaped body containing sedimenting particles according to claim 9, wherein an extension element having a shape in which at least part of an upper end of the liquid holding module extends to the outer side of the liquid holding module is provided on an upper end of the liquid holding module.

11. A method for producing a shaped body containing sedimenting particles, the production method having:
a step of supplying a liquid containing sedimenting particles from a supply apparatus storing the liquid to an inkjet-type ejection head; and
a step of ejecting the liquid from the ejection head as a liquid droplet to form a shaped body containing the sedimenting particles in a droplet landing element disposed in a direction of ejection of the liquid droplet;
wherein
the supply apparatus includes a storage module that stores the liquid and supplies the liquid to the ejection head from one end of the storage module in a central axis direction,
in the supplying step, the liquid is supplied to the ejection head, the liquid being agitated by rotating the storage module in a circumferential direction about a central axis of the storage module, and
in the forming step, the agitated liquid is ejected as the liquid droplet.

12. The method for producing a shaped body containing sedimenting particles according to claim 11, wherein
the shaped body contains a hydrogel obtained by a first substrate and a second substrate reacting,
the liquid contains one of the first substrate and the second substrate, and
the droplet landing element includes the other of the first substrate and the second substrate.

13. The method for producing a shaped body containing sedimenting particles according to claim 11, wherein the sedimenting particles are a biomaterial.
